(19) United States
(12) Patent Application Publication
(10) Pub. No.: US 2020/0335974 A1
(43) Pub. Date: Oct. 22, 2020

(54) Frequency Regulation with Augmented Energy Storage

(71) Applicant: Amber Kinetics, Inc., Union City, CA (US)

(72) Inventors: Zhujie Lin, Fremont, CA (US); Roger Nelson Hitchcock, San Leandro, CA (US); Matthew K. Senesky, Berkeley, CA (US); Edward Young Chiao, San Jose, CA (US); Seth R. Sanders, Berkeley, CA (US)

(21) Appl. No.: 16/391,140

(22) Filed: Apr. 22, 2019

(51) Int. Cl. H02J 3/32; H02J 15/00; H02J 3/30

(52) U.S. Cl. CPC H02J 3/32; H02J 3/30; H02J 15/00

(57) ABSTRACT

The invention is an augmented energy storage system that includes an energy storage subsystem that stores and supplies energy to an electric grid, a load bank that dissipates energy, a power control system that controls the flow of energy into and out of the energy storage subsystem and into the load bank, and an inverter that converts DC current to AC current used by the grid.

### BACKGROUND

### 1. Field of Art

This description generally relates to energy storage using flywheels. However, the invention may be applied to other applications where frequency regulation of an electric grid is desirable.

### 2. Description of the Related Art

Utilization of distributed energy storage is fundamental to modern utility grids that incorporate substantial time-variable, non-dispatchable, renewable energy generation. Distributed energy storage is also essential for stabilizing weak grid systems that do not have substantial dominant conventional rotating generation. Examples of the latter occur in relatively isolated settings with small grids, such as on islands and in the developing world. But, notably, the issue of weak regulation capacity is also present in some regions of North America, such as the ERCOT regional grid in Texas.

Distributed energy storage integrated with utility transmission and distribution systems, or on customer sites behind the meter. Based on siting, storage characteristics, and utility governance, energy storage can provide various services to utilities. These include peak shifting, load shifting, and provision of resiliency. In addition, it can provide ancillary services including provision of capacity, frequency regulation, frequency response, voltage regulation, and black start capability.

The subject invention pertains to frequency regulation. Frequency regulation concerns the regulation of utility grid frequency, with the classical underpinning based on use of rotating generation. Basically, if instantaneous real power demand exceeds generation, the overall grid frequency decreases as rotational kinetic energy is extracted from rotating generators and as well as from rotating ac motor loads. The opposite is true for the case where real power demand falls below the instantaneous generation level. Instantaneous mismatch in generation and load is unavoidable since perfectly accurate forecasting of load is not possible.

Frequency regulation has been conventionally implemented with thermal generation systems. Since a thermal generation plant can only source real power and cannot be curtailed to zero power without a complete shutdown, the dynamic range of adjustment is only a fraction of the plant's nameplate capacity rating.

FIG. 1 is a simple graphical representation of the power capacity range of a thermal generation plant. Typically, such a the plant is restricted to always operate in the range of 30-100% of its nameplate power rating, as illustrated by a segment 10. Thus, the dynamic regulation range, i.e. the ability of a plan to regulate power output in response to command signals, is 70% of the nameplate capacity. Note that FIG. 1 is illustrated as a two dimensional graph, rather than one dimensional, for consistency with FIGS. 2-3 hereinbelow.

In contrast to thermal plants, energy storage systems that interface with modern power electronic converters are capable of full scale up/down regulation, since full range power can be supplied or absorbed at command in such a system. Thus, whenever an energy storage system is neither fully charged nor fully discharged, it is capable of 200% dynamic range in its power capacity, accessing the full charge/discharge range.

FIG. 2 illustrates an analogous example power capacity graph for an energy storage plant. As can be seen, an energy storage plant has an additional state of charge (SOC) constraint, represented by the axis labeled SOC. When fully charged, the energy storage plant can only source power, and can thus source 0-100% of its nameplate power rating. In FIG. 2, this constraint is represented by a segment 20 at 100% SOC. When fully discharged, the plant can only absorb power, and can thus absorb −100% to 0% of its nameplate power rating. This portion of the characteristic is represented by a segment 22 at 0% SOC. For SOC in the range, 0%<SOC<100%, the power capacity is bounded by −100% to +100%, thus comprising a dynamic range of 200% of the nameplate capacity. This region is represented by the interior of a hatched rectangle 24.

Further, conventional thermal generation plants require a time scale of minutes to ramp from one power level to another. In contrast, an energy storage system interfaced with a modern power electronic interface can ramp in a sub-second timescale, enabling very accurate tracking of a wideband frequency regulation command signal.

Distributed energy storage is commonly realized with batteries in some form, inclusive of electrochemical, mechanical, and thermal technologies among others. However, flywheel energy storage, a type of energy storage system that stores energy as rotational kinetic energy, is emerging as an important alternative, with steel rotor flywheels exhibiting leading performance in the dollar/kwh metric due to underlying physics, steel material properties, and steel industry manufacturing experience. The features of +/−100% capacity range and essentially instantaneous signal tracking are inherent to flywheel energy storage systems.

A controllable resistive load bank can be integrated within a distributed energy storage system to increase the capacity range. Examples of resistive load banks occur in electric water heating, electric space heating, and electric heat pump systems used for water heating, refrigeration and heating-ventilating-air-conditioning (HVAC) applications. In these thermal applications, flexibility in time of use is often available since the systems under control are thermal in nature and have substantial internal thermal storage capacity. This latter utilization of controllable thermal loads is commonly accessed with the Demand Response framework where utility-controllable loads are used to augment regulation and capacity ancillary services.

### SUMMARY

The subject invention is an augmented energy system that provides frequency regulation to power grids by integrating a resistive load bank. Combining an energy storage system with a resistive load bank increases energy capacity.

Embodiments relate to a an augmented energy storage system that includes an energy storage subsystem that stores and supplies energy to an electric grid, a load bank that dissipates energy, a power control system that controls the flow of energy into and out of the energy storage subsystem and into the load bank, and an inverter that converts DC current to AC current used by the grid.

Embodiments further relate to an augmented energy storage system that includes a storage site in which a load bank is located on another section of a utility grid from the storage site.

### BRIEF DESCRIPTION OF DRAWINGS

Non limiting and non exhaustive embodiments of the present invention are described with reference to the following drawings. In the drawings, like reference numerals refer to like parts throughout the various figures unless otherwise specified.

FIG. 1 is a simple graphical representation of the power capacity range of a thermal generation plant.

FIG. 2 illustrates an analogous example power capacity graph for an energy storage plant.

FIG. 3 illustrates a power capacity curve that is obtained by combining an energy storage system with a load bank, referred to herein as an augmented energy system with an integrated load bank, which has a power rating equal to that of the energy storage system.

FIG. 4 illustrates an embodiment of an augmented energy storage system that includes an energy storage subsystem that stores and supplies power and an integrated load bank 45 that dissipates power.

FIG. 5 illustrates an embodiment of an augmented energy storage system in which the load bank is co-located on a local low-voltage AC bus of the system.

FIG. 6 illustrates an embodiment of an augmented energy storage system in which the load bank is located on a different section of a utility grid than a storage site that provides energy storage.

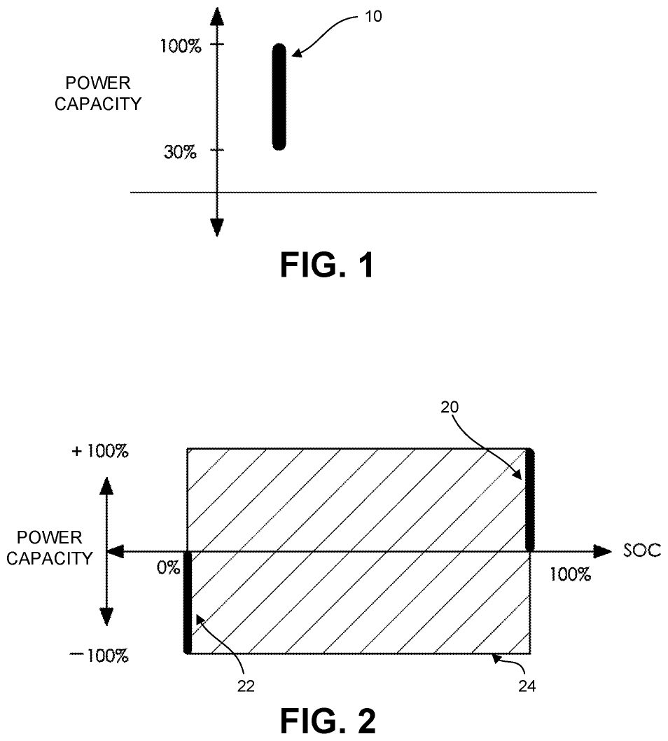

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, or devices. The following detailed description is, therefore, not to be taken in a limiting sense.

As used herein the following terms have the meanings given below:

Energy storage system—as used herein, refers to a system that stores and discharges energy. The energy storage system is typically coupled to an electric power grid, enabling the grid to store and withdraw energy as needed.

Flywheel unit or flywheel device—as used herein, includes a flywheel rotor that is typically a rotationally symmetric mass, such as a cylinder or disc, that spins. The rotor is physically coupled, directly or indirectly, to a motor/alternator that itself is electrically coupled to a converter, such as a back-to-back inverter system, constituting an AC-AC conversion subsystem. When power is received for storage, the rotor is driven, increasing the rotational speed of the flywheel rotor. The faster a flywheel rotor spins, the more energy it stores. When power is to be extracted, the flywheel rotor drives the motor/alternator. When coupled together, one or more flywheel units form an energy storage system.

Load bank or resistive load bank—as used herein, refers to one or more devices that develop an electrical load, apply the load to an electrical power source and convert or dissipate the resultant power output of the source. As used herein a load bank can be controlled so as to convert or dissipate a specified amount of power. Generally, commercially available load banks may be used to perform the functions ascribed to load banks as described herein.

Frequency regulation is a tool employed by power grid operators in cases when the system frequency gets too high or too low. The objective of frequency regulation is to maintain the grid at a specified frequency, typically 60 Hertz. Frequency regulation is accomplished by regulating power output; typically power generators increase or decrease power output for a period of time, referred to respectively as “regulation up” or “regulation down.”

Commands to a frequency regulation system may be supplied by a centralized regulator, eg. the independent system operator, to effect the intended regulation function. Alternatively, a frequency regulation system can operate as an autonomous regulator, by sensing and measuring instantaneous frequency at its point of common coupling to the utility. In this setting, the frequency regulation system develops its command signal locally by sensing the deviation from a nominal frequency setpoint. Both methods are encompassed in the scope of this invention.

### I. Augmentation

As can be seen in the example of FIG. 2, an energy storage system's capacity to provide frequency regulation service is potentially constrained by its state of charge. Many such systems are sized adequately so that they always operate within the interior of the hatched rectangle of FIG. 2. In some cases, a requirement for large energy absorption may arise, in excess of the charge capacity of an otherwise strategically dimensioned system. Since increasing the energy capacity may be costly, combining the energy storage system with a resistive load bank can be an economical strategy to overcome the energy capacity limitation. A resistive load bank is only capable of absorbing power, but not supplying power.

The subject invention, referred to as an augmented energy storage system, combines a resistive load bank, or simply “load bank”, with a given energy storage system on a common DC bus, on a common AC bus, or in proximity within a distribution or transmission grid system.

As previously discussed, the load bank can be implemented using a commercially available product. Examples of commercially available load banks include the SIMPLEX Stationary Load Bank from Simplex Inc. headquartered in Springfield, Ill.

Further, the load bank function can also be realized with controllable internal dissipation functions within a given energy storage system. In the case of a flywheel energy storage system, such internal dissipation processes can include use of gas drag, other forms of friction applied to the rotor, as well as electrical losses realized within the power conversion subsystem. The latter include losses in the power electronic conversion stages and electromechanical conversion subsystem, typically a motor/generator.

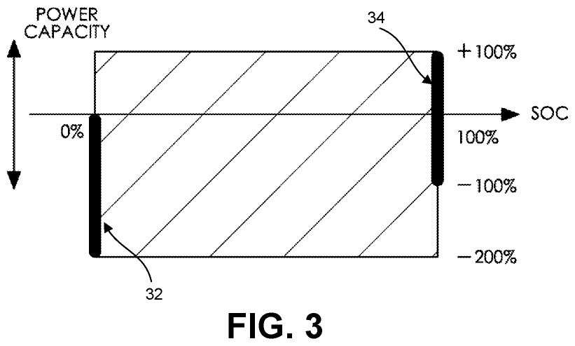

FIG. 3 illustrates a power capacity curve that is obtained by combining an energy storage system with a load bank, referred to herein as an augmented energy system with an integrated load bank, which has a power rating equal to that of the energy storage system. As can be seen, the total dynamic range is dramatically increased, relative to the curve of FIG. 2, to 300% of the energy storage nameplate rating for any SOC within the 0<SOC<100% range. For the fully discharged state, 0% SOC, capacity, illustrated by segment 32, spans −200% to 0%. This is because the energy storage system can absorb 100% of its power capacity rating and the resistive load bank can also absorb another 100% of power capacity. Thus, at 100% SOC, the power capacity spans −100% to 100%, as illustrated by segment 34, providing for the fully bilateral 200% dynamic power range of the underlying energy storage plant. Thus, in case of need for a long duration of down regulation where energy needs to be absorbed for any time period, the system remains fully capable of nominally full scale+/−100% regulation.

Since resistive load is inexpensive in comparison to energy storage, this augmented system is especially effective for performing frequency regulation. It should be noted that the additional installation costs for a resistive load bank as detailed here can be very low, since the other elements of the energy system are already in place.

### II. High Level Control Strategy

Introduction of energy storage to a utility system presents a new decision variable to the system, namely that of regulating the state of charge of the storage system at times when there is not a hard constraint to charge or discharge at a commanded power level. Opportunities to set storage state of charge occur when other dispatchable generation is on-line within the utility system, and not utilized at an extreme of capacity. Strategies for managing storage may utilize dynamic programming optimization over a receding finite horizon, also known as model predictive control (MPC), or other similar optimal control methodologies. Exemplary methods may break time into one hour segments, and then solve for hour-ahead and/or day-ahead policies, while keeping a horizon that scopes out for one week or more. Such an optimization needs to be informed by performance objectives, e.g. those that may occur in frequency regulation only, provision of capacity, peak/load shifting, or some combination of such ancillary and energy services.

In the case of pure frequency regulation with an augmented energy system that includes a resistive load bank, i.e. with no other service objective, an optimal strategy involves attempting to always keep the storage system fully charged. As seen in FIG. 3, at full state of charge (SOC), the system is capable of full up and down regulation. Further, the system has its maximum energy discharge capacity when fully charged, and so is least constrained in energy discharge capacity. This “greedy” policy may not be optimal if cost of energy is factored in. The greedy policy risks unnecessary dissipation if down regulation is called on when the system is fully charged. It may thus be strategic to bias the system to an intermediate state of charge, but still perhaps above 50%. There is clearly a strong dependence on specific economic criteria, in developing an optimal strategy for control.

### Configurations

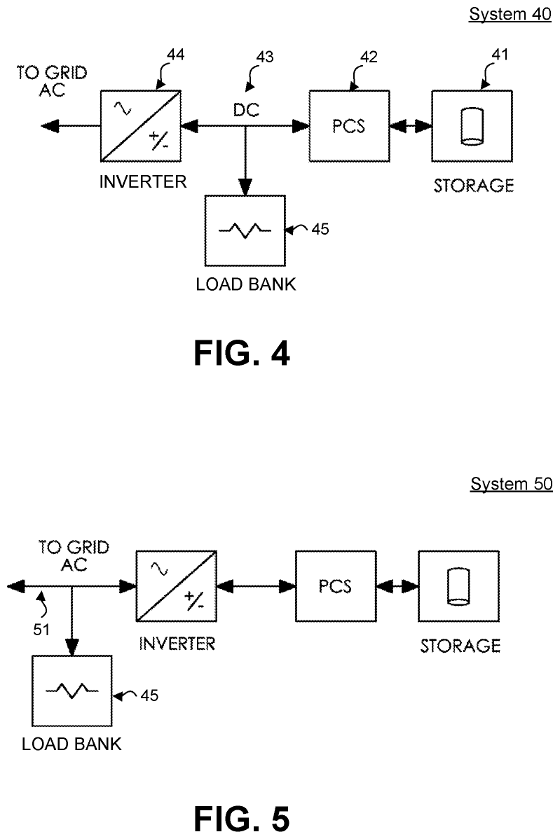

FIGS. 4, 5, and 6 illustrate alternative configurations, or embodiments, for an integrated load bank. Each embodiment places the load bank in a different location within an energy system. Other embodiments that include an integrated load bank in different locations are also within the scope of the subject invention.

FIG. 4 illustrates an embodiment of an augmented energy storage system 40 that includes an energy storage subsystem 41 that stores and supplies power, an integrated load bank 45 that dissipates power, a power control system that controls the flow of energy into and out of energy storage subsystem 41 and into load bank 45 and an inverter 44 that converts DC current used by elements of augmented energy storage system 40 to AC current used by an electric grid and vice versa. Load bank 45 is co-located on a DC bus 43 with other elements of augmented energy storage system 40. Storage sub system 41 may be a single storage unit, or a number of storage units that are coupled together. The energy storage units may be flywheels, batteries or or another type of energy storage device. Storage subsystem 41 may also be a combination of different types of energy storage units coupled together.

FIG. 5 illustrates an embodiment of an augmented energy storage system 50 in which load bank 45 is co-located on a local low-voltage AC bus 51 of system 50.

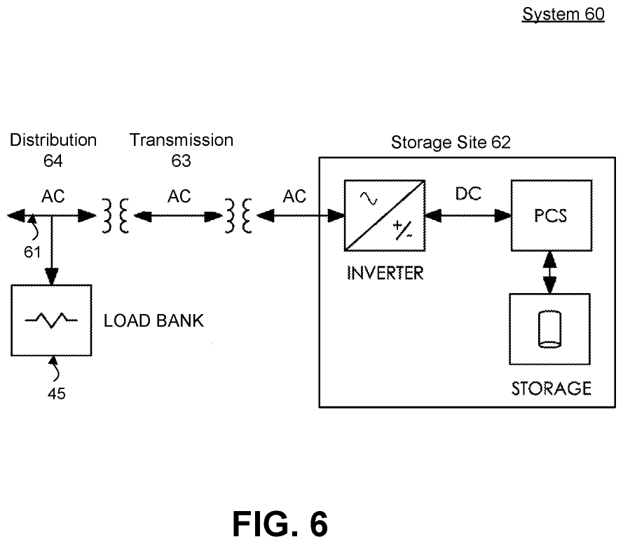

FIG. 6 illustrates an embodiment of an augmented energy storage system 60 in which load bank 45 is located on a different section of a utility grid 61 than a storage site 62 that provides energy storage. System 60 further includes a transmission 63 facility or subsystem and a distribution 64 facility. Transmission 63 refers to the portion of an electric grid that carries electrical energy from a generating site or storage site, such as storage site 62 to an electrical substation, referred to as distribution 64. Distribution 64 facility distributes the electrical energy to subscribers that use the energy. In this embodiment, load bank 45 connects at a different substation from the substation to which storage site 62 connects.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system, comprising:
an energy storage subsystem that stores and supplies energy to an electric grid;
a load bank that dissipates energy;
a power control system that controls the flow of energy into and out of the energy storage subsystem and into the load bank; and
an inverter that converts DC current to AC current used by the grid.

2. The system of claim 1 wherein the load bank is co-located on a DC bus with the energy storage subsystem, the power control system, and the inverter.

3. The system of claim 1 wherein the energy storage subsystem comprises a plurality of flywheel units.

4. The system of claim 1 wherein the energy storage subsystem comprises a plurality of battery units.

5. The system of claim 1 wherein the load bank is co-located on a local low-voltage AC bus.

6. The system of claim 5 wherein the energy storage subsystem comprises a plurality of flywheel units.

7. The system of claim 5 wherein the energy storage subsystem comprises a plurality of battery units.

8. A system, comprising:
an energy storage site that stores and supplies energy to an electric grid;
a transmission facility that conveys electrical energy from the storage to a distribution facility; and
a load bank that connects to the distribution facility and that dissipates energy.

9. The system of claim 8 wherein the energy storage site comprises:
an energy storage subsystem that stores energy from the electric grid and supplies energy to the electric grid;
a power control system that controls the flow of energy into and out of the energy storage subsystem and into the load bank; and
an inverter that converts DC current used by the storage site to AC current used by the electric grid.

10. The system of claim 9 wherein the energy storage subsystem comprises a plurality of flywheel units.

11. The system of claim 9 wherein the energy storage subsystem comprises a plurality of battery units.
